(19) United States
(12) Patent Application Publication
(10) Pub. No.: US 2005/0272455 A1
(43) Pub. Date: Dec. 8, 2005

(54) Management of devices

(75) Inventor: Paul Oommen, Irving, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/956,090

(22) Filed: Oct. 4, 2004

Related U.S. Application Data
(60) Provisional application No. 60/576,821, filed on Jun. 4, 2004.

(51) Int. Cl. H04Q 7/38

(52) U.S. Cl. 455/518; 455/517

(57) ABSTRACT

A method for simultaneously managing a plurality of mobile devices, the method including the steps of initiating a management session, forming a group of mobile devices to be managed in the session, forming a management message including an identifier specific to the management session and to the group of the mobile devices to be managed and transmitting the management message to the plurality of mobile devices.

### FIELD OF THE INVENTION

This invention relates to transmitting data to a mobile device and particularly to transmitting data to a plurality of mobile devices.

### BACKGROUND OF THE INVENTION

As the functionality of mobile devices becomes more complex, the task of configuring and maintaining the features and services on the mobile devices becomes increasingly arduous. Network operators are required to manage the mobile devices, for example by activating users, provisioning devices and periodically updating parameters stored in the devices. In order to reduce the cost and effort of managing the devices, it is currently possible to remotely manage device settings and applications, this is known as device management (DM).

Over-the-air (OTA) management protocols allow data to be transmitted to mobile devices via wireless transmission media. One example of OTA Device Management is the re-programming of a Preferred Roaming List (PRL). When a mobile user is abroad and switches on the mobile device for the first time, the mobile device performs a search for all available networks. The mobile device then reads from the PRL the preferred networks and the order in which they should be offered to the user. Since preferred networks are constantly changing as new roaming agreements are made, it is necessary to frequently update the PRL in the mobile device. This is achieved by downloading the revised PRL remotely using OTA technology.

Current protocols developed in OMA (Open Mobile Alliance) DM provide an integrated framework for OTA management of 3G mobile devices. The existing OMA DM protocol is an XML based protocol which defines a management framework and a set of messages exchanged between one mobile device and an entity in the network called the management server. A management session is set up between the management server and the mobile device, and an OTA message is constructed which is unique to the mobile device.

Another protocol for OTA management developed by 3GPP2 is the over-the air handset configuration management (IOTA-HCM) protocol. IOTA-HCM protocol is an XML based protocol which is again configured to set up a management session between the management server and the mobile device

The point to point model between the management server and the mobile device of existing protocols, such as OMA DM and IOTA-HCM, therefore requires an equal number of management sessions and OTA messages as there are mobile devices. In the case where a large number of mobile devices are to be managed, this may result in flooding the network with management related traffic.

It is therefore an object of the present invention to provide a method for device management for a plurality of mobile devices which avoids the above mentioned problems of existing protocols.

It is a further object of the present invention to provide a method for improving current OTA DM protocols.

### SUMMARY OF INVENTION

According to a first aspect of the present invention there is provided a method for simultaneously managing a plurality of mobile devices, said method comprising the steps of: initiating a management session; forming a group of mobile devices to be managed in the session, forming a management message including an identifier specific to the management session and to the group of said mobile devices to be managed; and transmitting said management message to said plurality of mobile devices.

According to a second aspect of the present invention there is provided a management server for managing a plurality of mobile devices comprising: means for initiating a management session; means for identifying a group of mobile devices to be managed in the session; means for forming a management message including an identifier specific to the management session and to the group of said mobile devices to be managed; and means for transmitting said management message to said plurality of mobile devices.

According to a third aspect of the present invention there is provided a mobile device for use in a communication network comprising: means for responding to an announcement of a management session by indicating an acceptance to join a group of mobile devices to be managed by a management session; means for receiving a management message including an identifier specific to the management session and to the group of mobile devices; means for managing the mobile device in accordance with the management message.

According to a fourth aspect of the present invention there is provided a communications network comprising: a management server; and a plurality of mobile devices, wherein the management server is arranged to identify a group of mobile devices to be managed by a management session and to transmit a management message to said plurality of mobile devices, said management message including an identifier specific to the management session and to the group of mobile devices to be managed.

According to a fifth aspect of the present invention there is provided a method of simultaneously managing a plurality of mobile devices, said method comprising the steps of: broadcasting a message announcing a management session;
forming a management message including an identifier specific to the management session; and transmitting said management message to said plurality of mobile devices.

Embodiments of the present invention can help the widespread adoption of mobile services, as it provides a mechanism for a large number of users to simultaneously subscribe to new services without the need to provide an independent session for each device. This allows the network operators a fast and easy way to introduce new services and manage provisioned services by dynamically adjusting to changes and ensuring a required level of service without creating a high number of messages and reducing capacity.

### BRIEF DESCRIPTION OF THE DRAWINGS

Embodiments of the present invention will now be described by way of example with reference to the accompanying drawings, in which:

FIG. 1 is a simplified representation of a cellular network

FIG. 2 is a schematic diagram of a communication network

FIG. 3 is flow chart representing an embodiment of the present invention;

FIG. 4 is an XML header of a message derived at the management server in accordance with an embodiment of the present invention;

FIG. 5 is an XML header of a message derived at a mobile device in accordance with an embodiment of the present invention.

### DETAILED DESCRIPTION OF EMBODIMENTS OF THE INVENTION

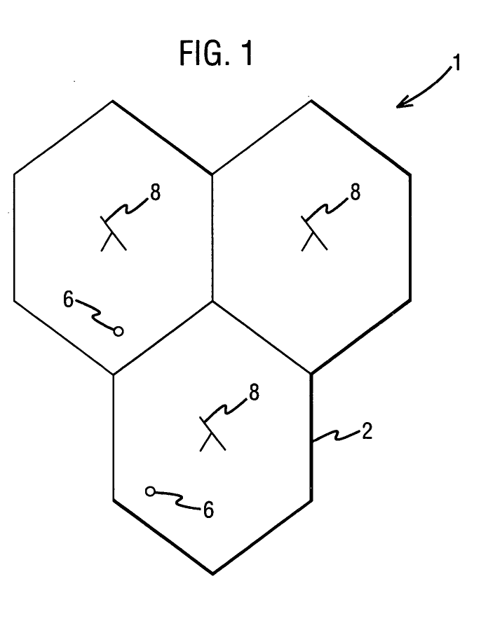

FIG. 1 shows a simplified presentation of a cellular system showing an arrangement in which base stations 8 (only three shown for clarity) of the cellular system 1 provide radio coverage areas i.e. cells 2. Each radio coverage area 2 is typically served by a base station. It should be appreciated that one cell may include more than one base station site. A base station apparatus or site may also provide more than one cell. The shape and size of the cells 2 depend on the implementation and may be different from the illustrated shapes. It should be appreciated that in some systems the base station may be referred to as Node B.

Two mobile devices 6 are also shown. It shall be appreciated that typically a number of mobile devices will be in communication with each base station. Each base station is arranged to transmit signals to and receive signals from the mobile devices 6 via a wireless interface. Likewise, the mobile devices 6 are able to transmit signals to and receive signals from the base stations.

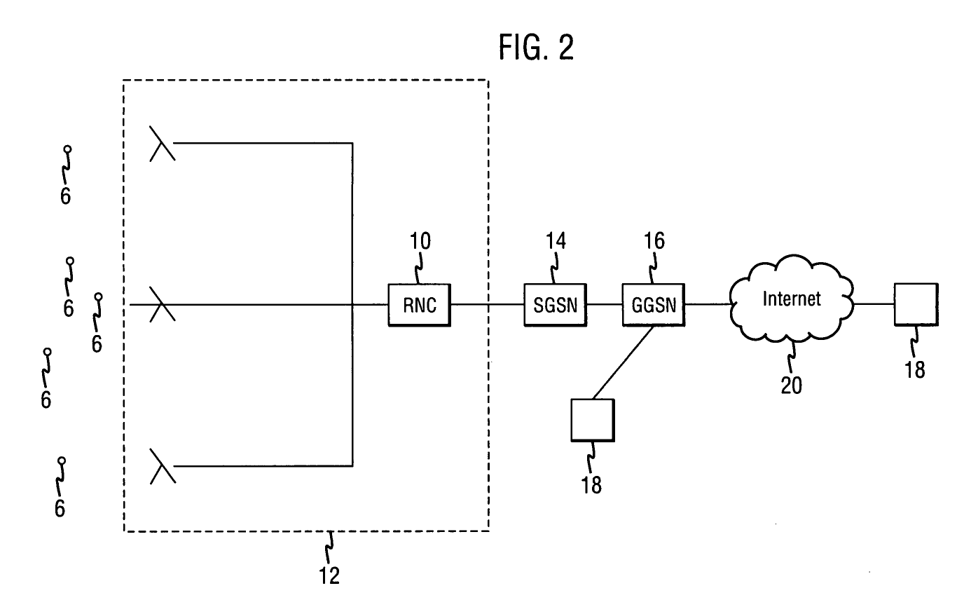

Each of the base stations is connected to an access network controller such as a radio network controller (RNC) 10 of a UMTS terrestrial radio access network (UTRAN) (shown in FIG. 2). The radio network controller may be connected to appropriate core network entities of the cellular system, such as an SGSN (serving general packet radio service support node) 14 for packet switched communication and additionally an MSC (mobile switching centre) for circuit switched communication.

FIG. 2 depicts part of the architecture of a UMTS (universal mobile telecommunications network). This shows a plurality of mobile devices 6 such as PDAs (Personal Digital Assistants), mobile phones and laptops; a radio access network (RAN) 12 comprising base stations 8 and an RNC (radio network controller) 10; an SGSN (serving GPRS support node) 14; a GGSN (gateway GPRS support node) 16; a management server 18; and the Internet 20. In FIG. 2 the management server 18 is directly connected to an operator's GPRS domain via the GGSN 16. In an alternative embodiment, the management server may be connected to an operator's GGSN through the internet.

The implementation of the RAN 12, SSGN 14 and GGSN 16 are well known in the art, and for the purposes of the discussion of embodiments of the present invention it is assumed that they operate in accordance with standard, known techniques except where stated.

As described above, according to existing protocols, when managing a plurality of mobile devices 6, separate management sessions are required for provisioning and managing each mobile device. Therefore even when a plurality of mobile devices are updated with the same management data a unique management session having a unique session ID is established between each mobile device 6 and the management server 18. Accordingly a unique OTA message is constructed for each mobile device.

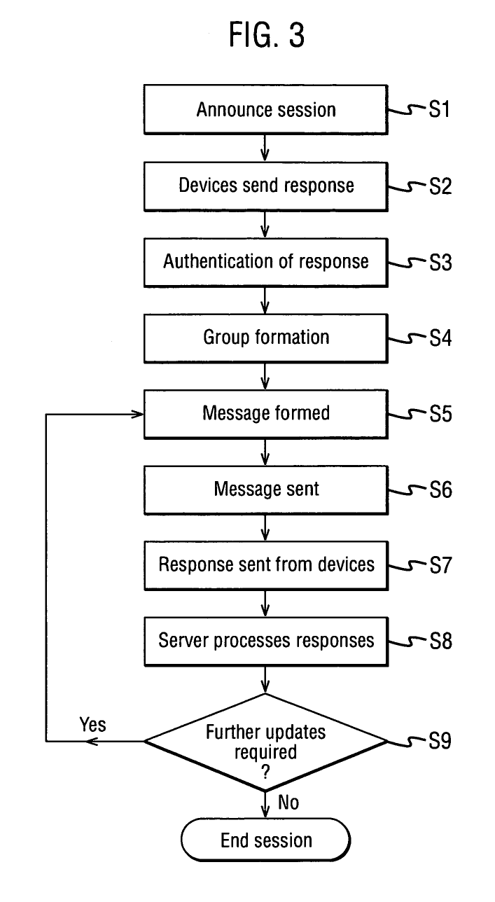

According to embodiments of the present invention, a plurality of mobile devices may be updated with the same data, e.g. relating to management data or parameters, with the same OTA message in a single multicast session. A preferred embodiment of the invention will now be discussed in relation to FIG. 3.

In step 1 (S1) of FIG. 3 the management server 18 announces a management session to the mobile devices in order to alert the devices to the management session. The session may be announced by SMS, cell broadcast services (CBS) or Short Data Bursts. This list is not exhaustive.

In one embodiment of the invention, announcements may be made to a limited group of mobile devices within a cell, or plurality of cells. For example an announcement may be made to existing subscribers of a particular service for a service upgrade. When sending announcements to a selected group of mobile devices the announcement is multicast to the mobile devices. The multicast message is routed to the mobile devices identified by an IP multicast address. Multicast message routing is well known in the art and not discussed in detail herein.

In another embodiment of the present invention the announcement may be sent to all the devices in the cell. When an announcement is made to all devices the announcement is broadcast within the cell.

In a preferred embodiment of the invention a session identifier, or session ID, is included in the announcement to identify the session.

In step 2 (S2), the devices which have received the message announcing the session make a decision about whether or not to join the session. This may be an automated decision, or may require user input. If the device is to join the session, the device sends a message to the management server 18 accepting to join the session. The message sent from the device may include information identifying the device and information for authentication. If the device is not to join the session the device may either send a message rejecting to join the session or send no response.

In step 3 (S3), the management server 18 receives the responses from the mobile devices. The authentication information provided in the responses from devices wishing to join the session is checked against subscription data provided by the network operator.

In step 4 (S4) the management server 18 groups the devices wishing to join the session which have been authenticated. This group is given an identifier, hereinafter referred to as a multicast group ID. This is different to the IP multicast address used to route a multicast message. In a preferred embodiment of the invention the multicast group ID also identifies the time the update is sent and the data which is updated. For example the same group of mobile devices, would be given a different multicast group ID when further data is sent at a different time. The multicast group ID accordingly allows the server to identify both the data sent and the time the data is sent, in addition to the devices in the group.

In a preferred embodiment of the invention, the multicast group ID may also be used by the mobile device to reference a specific management action for which the data is intended, in addition to identifying the group. In one embodiment of the invention the multicast group ID may be used to reference a location or node in a management tree in the mobile devices, structured on the basis of services and applications. For example, the multicast group ID may be used to identify the node where information for a particular application is stored in each of the mobile devices in the group. Management trees are known in the art and will not be described herein.

Alternatively the multicast group ID may only be used to identify the group of mobile devices.

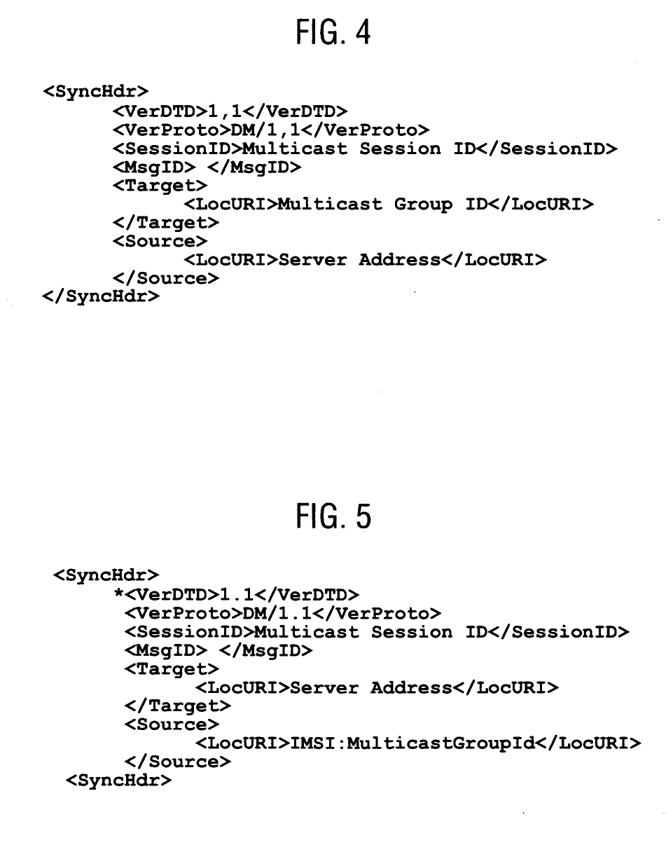

In step 5 (S5) the management server forms a single OTA message to update the mobile devices having the same multicast group ID, with data relating to the announced session. In accordance with a preferred embodiment of the present invention, the OTA message is an XML message. The data to be downloaded to the mobile devices is inserted into the body of the OTA message. The header of the OTA message in accordance with a preferred embodiment of the present invention is shown in FIG. 4.

As shown in FIG. 4, the Session ID element in the message header SyncHdr includes a ‘Multicast Session ID’. In a preferred embodiment of the invention, the multicast session ID is derived from the multicast group ID described above and the session ID which is assigned when the session is announced. The multicast session ID enables the management server to manage data relating to the multicast session. Alternatively the multicast session ID may be the same as the session ID assigned when the session is announced.

In an alternative embodiment of the present invention the multicast session ID may be derived from an application or service identity specified by a service provider, or from the time the multicast session is sent. The skilled person will appreciate that there are other parameters from which the multicast session ID may be derived.

In a further alternative embodiment the multicast session ID may be specified at random.

Since the multicast session ID is specific to both the session and the mobile device group, the multicast session ID identifies both the mobile device group and the session.

As shown in FIG. 4 the OTA message originating from the server includes the multicast group ID in the Target element of the header. The server address is included in the Source element. In a preferred embodiment of the invention both the multicast group ID and the server address are specified as Universal Resource Indicators (URI)

In an alternative embodiment of the present invention the target URI may instead specify an application related URI.

Referring again to FIG. 3, in step 6 (S6), the management server 18 transmits the message to the devices of the group as a multicast message, using the multicast mechanism supported in the network and thereby establishing a point to multipoint connection. Only one copy of such a specially constructed message is sent to all devices in the group. As previously stated, the underlying multicast mechanism, including routing the multicast message is well known in the art and will not be described in detail herein.

In step 7 (S7), each mobile device in the group receives and processes the OTA message. A DM client installed in each mobile device processes the information received in the OTA message and performs the necessary update, or carries out an instruction included in the message. The way in which an OTA message is processed is known in the art and will not be described in detail herein. Each mobile device then sends an individual response to the server. The connection established between each mobile device and the server 18 by the response originating from the mobile device is a point to point connection. The structure of the header of the response message originating from the mobile device can be seen in FIG. 5.

As shown in FIG. 5, in a preferred embodiment of the invention the Source element of the header includes the multicast group ID in addition to a device specific unique address, for example the IMSI (International Mobile Subscriber Identity) of the device. Additionally, the Session ID element of the header includes the multicast session ID and the Target element of the header includes the server address.

In an alternative embodiment of the present invention the source element of the header may instead specify an application related URI in addition to the device specific unique address.

With reference to FIG. 3, at step 8 (S8) the server collects and processes the responses sent from the mobile devices. Since the IMSI has been included in the source element of the header, the server is able to distinguish which response is from which device. Furthermore, since the multicast session ID is specified in the Session ID element the server is able to identify which session the message relates to.

At step 9 (S9) it is determined whether further updates are required, and whether the update was unsuccessful for some devices. If it is determined that further updates are required, the process returns to step 5 and a second OTA message is created. In a preferred embodiment of the invention, since the OTA message relates to the same session, the second OTA includes the same multicast session ID as the first OTA message.

In one embodiment of the present invention, if it is determined that only a small number of devices require further updates a point to point connection may be established between the server and each device. The network may set a threshold to decide when point to point sessions are more effective.

If it is determined that no further updates are required the session is ended. If the mobile wishes to unsubscribe from the service the mobile may request to leave the group. Otherwise later updates may be sent to the same group using the same group ID.

The embodiment described above relates to OTA management protocols, however the invention may also be applied to protocols used to manage fixed network entities such as routers and physical layer devices.

It is noted herein that while the above describes exemplifying embodiments of the invention, there are several variations and modifications which may be made to the disclosed solution without departing from the scope of the present invention as defined in the claims

1. A method for simultaneously managing a plurality of mobile devices, said method comprising the steps of:
initiating a management session;
forming a group of mobile devices to be managed in the session;
forming a management message including an identifier specific to the management session and to the group of said mobile devices to be managed; and
transmitting said management message to a plurality of mobile devices.

2. The method as claimed in claim 1, further comprising the step of:
announcing the management session to the plurality of mobile devices.

3. The method as claimed in claim 2, wherein the step of announcing the management session comprises broadcasting an announcement.

4. The method as claimed in claim 2, wherein the step of announcing the management session comprises transmitting a multicast announcement message to the plurality of mobile devices.

5. The method as claimed in claim 2, further comprising the step of:
rejecting or accepting the management session by at least one mobile device of the mobile devices in response to the announcing step.

6. The method as claimed in claim 5, wherein forming the group of said mobile devices comprises forming the group of said mobile devices from mobile devices which have accepted the management session.

7. The method as claimed in claim 1, wherein the management message comprises a multicast message.

8. The method as claimed in claim 1, wherein the management message comprises a single XML message which is sent to at least one mobile device in the group.

9. The method as claimed in claim 1, further comprising the step of:
assigning a group ID to the group.

10. The method as claimed in claim 1, further comprising the step of:
assigning a session ID to the session.

11. The method as claimed in claim 9, further comprising the step of:
assigning a session ID to the session.

12. The method as claimed in claim 11, wherein the identifier included in the management message is derived from at least one of the group ID and the session ID.

13. The method as claimed in claim 10, wherein the identifier included in the management message comprises the session ID.

14. The method as claimed in claim 1, further comprising the step of:
assigning the identifier included in the management message at random.

15. A management server for managing a plurality of mobile devices, the server comprising:
means for initiating a management session;
means for identifying a group of mobile devices to be managed in the session;
means for forming a management message including an identifier specific to the management session and to the group of said mobile devices to be managed; and
means for transmitting said management message to a plurality of mobile devices.

16. The management server as claimed in claim 15, further comprising:
means for alerting the plurality of mobile devices to the session.

17. The management server as claimed in claim 16, further comprising:
means for identifying mobile devices which have sent a response accepting to join the session; and
means for forming a group including at least one of the mobile devices which have accepted to join the session.

18. The management server as claimed in claim 15, further comprising:
means for transmitting the management message, wherein the management message comprises a multicast message.

19. The management sever as claimed in claim 15, further comprising:
means for forming the management message to include an XML message.

20. The management server as claimed in claim 15, further comprising:
means for assigning a group ID to the group.

21. The management server as claimed in claim 15, further comprising:
means for assigning a session ID to the session.

22. The management server as claimed in claim 20, further comprising:
means for assigning a session ID to the session.

23. The management server as claimed in claim 22, further comprising:
means arranged to derive the identifier included in the management message from at least one of the group ID and the session ID.

24. The management server as claimed in claim 21, further comprising:
means arranged to derive the identifier included in the management message from the session ID.

25. The management server as claimed in claim 21, further comprising:
means arranged to derive the identifier included in the management message at random.

26. A mobile device for use in a communication network comprising:
means for responding to an announcement of a management session by indicating an acceptance to join a group of mobile devices to be managed by a management session;
means for receiving a management message including an identifier specific to the management session and to the group of mobile devices; and
means for managing the mobile device in accordance with the management message.

27. A communications network comprising:
a management server; and
a plurality of mobile devices, wherein the management server is arranged to identify a group of mobile devices to be managed by a management session and to transmit a management message to said plurality of mobile devices, said management message including an identifier specific to the management session and to the group of mobile devices to be managed.

28. A method of simultaneously managing a plurality of mobile devices, said method comprising the steps of:
broadcasting a message announcing a management session;
forming a management message including an identifier specific to the management session; and
transmitting said management message to a plurality of mobile devices.
